(19) United States
(12) Patent Application Publication
(10) Pub. No.: US 2010/0057486 A1
(43) Pub. Date: Mar. 4, 2010

(54) SYSTEM AND METHOD FOR LINKING E-MAIL ADDRESS WITH POSTAL ADDRESS

(76) Inventors: Ho Yon Kim, Daejeon (KR); Doo Sik Kim, Daejeon (KR); Jong Heung Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/354,065

(22) Filed: Jan. 15, 2009

(30) Foreign Application Priority Data
Aug. 27, 2008 (KR) 10-2008-0084103

(51) Int. Cl. G06Q 10/00

(52) U.S. Cl. 705/1

(57) ABSTRACT

The present invention relates to a linkage system and a linkage method that links an e-mail address with a postal address. The present invention relates to a system and a method that delivers a postal item to a real address of a customer corresponding to an e-mail address, even though the e-mail address is entered in the postal item. According to the present invention, since the e-mail address and the postal address are linked with each other, even if the user's residence is changed, the changed address can be confirmed by using the e-mail address that is linked with the postal address. Accordingly, it is possible to prevent the loss of the postal item. In addition, since a semi-permanent e-mail address is used instead of the postal address, which often changes, in a communication way between individuals, a sender can send the postal item by using only the e-mail address without worrying about the address change of recipient, even when not knowing the address of the recipient.

### CROSS-REFERENCE TO RELATED APPLICATION

This application claims priority to and the benefit of Korean Patent Application No. 10-2008-0084103 filed in the Korean Intellectual Property Office on Aug. 27, 2008, the entire contents of which are incorporated herein by reference.

### BACKGROUND OF THE INVENTION

(a) Field of the Invention

The present invention relates to a system and a method for linking a postal address. More particularly, the present invention relates to a system and a method for linking an e-mail address with a postal address.

This work was supported by the IT R&D program of MIC/IITA [2006-X-001-03, Development of Element Technology for Real-Time Postal Logistics].

(b) Description of the Related Art

Recently, when a customer address is changed by a move, in order to receive a postal item at the changed address, a database should be modified to reflect the changed address, or a postal item transmitting service should be undertaken. Otherwise, inconvenience will undoubtedly occur, for example, the return or loss of the postal item. This is the one of causes that greatly damages quality and reliability of a postal service.

In order to solve this problem, the changed customer address should be updated, or an automatic transmission service should be developed through a change-of-address report in an effort to reduce the return of the postal items. Furthermore, a service that processes information on the customer address prior to the change so as to update the address of many sites to which the customer subscribes at the same time has been developed. However, since the change-of-address service increases the workload of a postman, a service usable period thereof is restricted. Moreover, in a case of the address update service, even though some apply for the service, there is a limit in that the address information of an enterprise or an individual not applying for this service is not updated.

Meanwhile, in order to avoid the inconvenience of the update, a plan for granting a lifelong address ID to every individual address has also been studied. However, a concept of a lifelong address ID may be an ideal model, but it brings about the inconvenience that the lifelong address ID should be managed only for the sake of the reception of the postal item.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a linking apparatus and a linking method that are capable of using an e-mail address as a postal address.

An exemplary embodiment of the present invention provides a linking system for linking an e-mail address with a postal address, the linking system including: an e-mail address inputting section for receiving an e-mail address that is output to a postal item or input by a user; a postal address mapping section that searches and confirms a postal address corresponding to the e-mail address, based on the received e-mail address; and a postal item processing section that processes a postal item according to the postal address confirmed by the postal address mapping section.

Another embodiment of the present invention provides a linking method linking on an e-mail address with a postal address, the linking method including: collecting an e-mail address from postal items introduced into a sorter; searching a postal address corresponding to the collected e-mail address from a linkage database and outputting the postal address to the postal item; and after generating allocation information on a sorting compartment that sorts the postal items based on the output postal address, controlling so as to sort out the postal items according to the generated allocation information on the sorting compartment.

### BRIEF DESCRIPTION OF THE DRAWINGS

FIG. 1 is a configuration diagram of a mail address linking system according to an exemplary embodiment of the present invention.

FIG. 2 is a flowchart illustrating a mail address linking method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements. In addition, the terms “-er”, “-or”, and “section” described in the specification mean units for processing at least one function and operation and can be implemented by hardware components, software components, or combinations thereof.

With respect to a system and a method for linking an e-mail address with a postal address according to an exemplary embodiment of the present invention, it will be described herein with reference to the accompanying drawings.

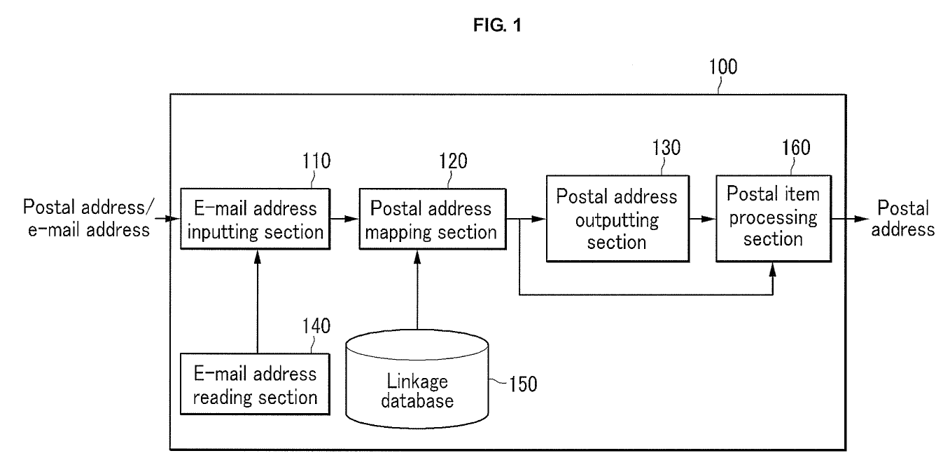

FIG. 1 is a configuration diagram of a postal address linking system according to an exemplary embodiment of the present invention.

As illustrated in FIG. 1, a postal address linking system 100 includes an e-mail address inputting section 110, an e-mail address reading section 140, a postal address mapping section 120, a postal address outputting section 130, a linkage database 150, and a postal processing section 160. Here, the postal address linking system 100 can be embodied in various kinds of postal processors. In the exemplary embodiment of the present invention, as an example, a sorter will be described as a postal processor.

The e-mail address inputting section 110 collects an e-mail address that is input by a user. The e-mail address can be input by using various input devices such as a text input device, a camera, or a scanner. Moreover, the e-mail address inputting section 110 determines whether the e-mail address is input as text or any type other than text.

According to the exemplary embodiment of the present invention, as an example, the e-mail address of a postal item is input as text and any type other than text. First, if the e-mail address is input as text, when a sender sends postal items by a home-delivery service or when a customer purchases an article at an on-line shopping mall, a person who collects the delivery or a customer who uses the shopping mall inputs the e-mail address of a receiver who receives the postal item by using the input device (e.g., keyboard or PDA). At this time, the input e-mail address is input into the e-mail address inputting section 110 as text. However, when the sender of the postal item makes a note of the e-mail address or attaches it by outputting a bar code including e-mail address information at a post office, the e-mail address inputting section 110 receives a bar code-type or an image-type e-mail address.

Meanwhile, when the e-mail address is input as any type other than text, for example by using a camera or a scanner, the e-mail address is read by the e-mail address reading section 140. According to the exemplary embodiment of the present invention, the e-mail address reading section 140 is configured by a bar code reader or an image reader, but it should be understood that the invention is not necessarily limited thereto.

If the e-mail address is input into the e-mail address inputting section 110 as the bar code or the image, the e-mail address reading section 140 reads image-type information or bar code-type information, thereby converting it into an e-mail address of a string. With respect to the way of converting into the e-mail address of the string from the image-type information or bar code-type information, since it is already known to those skilled in the art, a detailed description will be omitted in the exemplary embodiment of the present invention.

The postal address mapping section 120 receives the e-mail address of the string from the e-mail address inputting 110 or the e-mail address reading section 140 and searches whether or not the postal address corresponding to this e-mail address exists in the linkage database 150. When the postal address exists in the linkage database 150, the relevant postal address is collected. However, when the postal address does not exist in the linkage database 150, the postal item is returned to the sender who has sent out the postal item.

The postal address outputting section 130 outputs the postal address, which is collected by the postal address mapping section 120, through various output devices or provides the postal address so as to be utilized in other devices. Here, other devices illustrate a sorter located in a postal center, but it should be understood that the invention is not necessarily limited thereto.

The linkage database 150 stores the e-mail address and the postal address corresponding thereto. Moreover, in a case where the postal address mapping section 120 searches whether or not the postal address regarding the e-mail address exists in the linkage database 150, when the postal address exists in, the linkage database 150 provides the relevant postal address to the postal address mapping section 120. Meanwhile, when the postal address does not exist therein, the linkage database 150 provides the message, which returns the relevant postal item, to the postal address mapping section 120.

When the postal address regarding the e-mail address is changed, the linkage database 150 asks a user of the e-mail address to change the address. Moreover, by being connected to a database for storing the e-mail address and a database for managing the postal address to each other, when the postal address is changed through an address moving procedure, the linkage database 150 informs the changed postal address of the database in which the e-mail address is stored, thereby allowing both databases to be changed. According to the exemplary embodiment of the present invention, the linkage database 150 is included in the postal address linking system 100, but the linkage database 150 may be located at a center server or the like so as to receive the relevant information.

The postal item processing section 160 processes the postal items, that is, the postal item processing section 160 sorts the postal items into sorting compartments according to the postal addresses that are identified in the postal address mapping section 120. At this time, the postal item processing section 160 may directly process the postal items according to the postal addresses that is identified in the postal address mapping section 120, and may process the postal items after the postal address outputting section 130 outputs the postal addresses to the postal items. Furthermore, according to the exemplary embodiment of the present invention, the postal item processing section 160 is included in the postal address linking system 100, but it should be understood that the invention is not necessarily limited thereto.

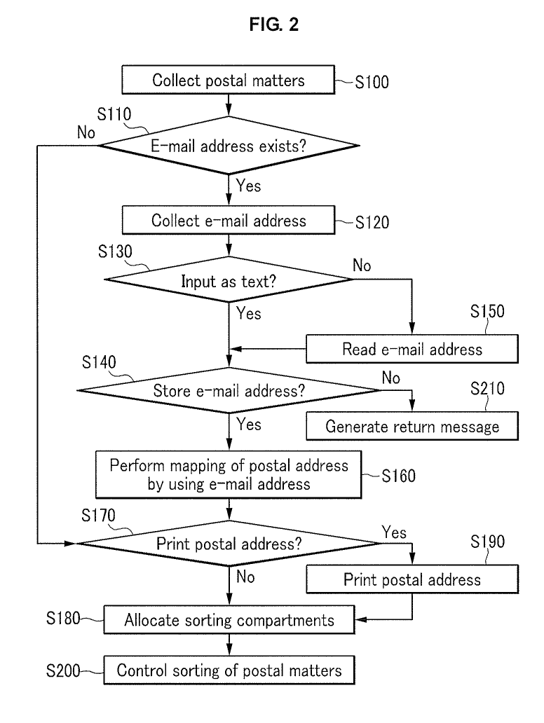

A method of sorting the postal items by using the postal address linkage system that is provided with the above constituent elements and substantially linking the postal addresses will be explained in detail with reference to FIG. 2.

FIG. 2 is a flowchart illustrating a postal address linking method according to the exemplary embodiment of the present invention.

As illustrated in FIG. 2, when the postal items are collected into the sorter or when the postal items are generated by user's purchases through an on-line shopping mall (S100), the e-mail address inputting section 110 determines whether the postal address is output with respect to the relevant postal item or whether the e-mail address regarding the relevant postal item is input as text or any type other than text (S110).

As a result of determination from the e-mail address inputting section 110, when the postal address is output with respect to the postal item, the sorter allocates the sorting compartments for the postal items by a general manner and then controls them such that the postal items can be sorted (S170). However, when the e-mail address is output to the postal item or when the e-mail address is input as text, the e-mail address is collected (S120), and then the e-mail address inputting section 110 determines whether or not the relevant e-mail address is input as text (S130).

When the user inputs the text-type e-mail address by using a text input device, the postal address mapping section 120 receives the e-mail address, searches the linkage database 150, and determines whether or not the postal address corresponding to the relevant e-mail address is previously stored in the linkage database 150 (S140). At this time, the most recent updated postal address is stored in the linkage database 150. That is, when a resident moves to another area, the linkage database 150 provides the message to the relevant resident so as to renew the postal address corresponding to the e-mail address or renews the relevant postal address so as to correspond to the e-mail address through a change of address.

If the e-mail address and the postal address corresponding thereto are stored in the linkage database 150, the postal address mapping section 120 performs the mapping of the postal address by using the e-mail address (S160). The postal address mapping section 120 transmits the mapped postal address to the postal address outputting section 130, and the postal address outputting section 130 determines whether to print the relevant postal address on the postal item (S170). This is how a postman delivering the postal items determines a destination address of the relevant postal item, when the address for the postal item is the e-mail address.

In step S170, if determining to print the postal address on the postal item, the postal address outputting section 130 prints the relevant postal address on the postal item (S190) and then transmits the postal address to the sorter such that the postal item can be sorted. The sorter allocates the sorting compartments corresponding to the postal items by using the postal addresses (S180) and controls the sorting units such that the postal items are sorted on the basis of the information related to the sorting compartments that are allocated (S200). However, instep S170, if determining not to print the postal address on the postal item, the postal address outputting section 130 does not print the postal address on the postal item and immediately performs the procedure after step S180.

Next, as a result of the determination in step S130, when the e-mail address is input as a bar code or image other than text, the e-mail address reading section 140 reads the e-mail address from the bar code or the image (S150). With respect to the way of reading the information from the bar code or the image, since this is already known to those skilled in the art, a detailed description thereof will be omitted in the exemplary embodiment of the present invention.

In step S140, when the postal address mapping section 120 determines that the e-mail address is not stored in the linkage database 150, the postal address is not provided for the relevant postal matter. Accordingly, the postal address mapping section 120 generates a return message such that this postal item can be returned to the sender (S210).

As described above, since the postal item is sorted and sent out by linking the e-mail address with the postal address, it can be possible to prevent an erroneous delivery caused by invalid address information that results from a change of residence.

According to the embodiment of the present invention, since the e-mail address and the postal address are linked with each other, even though the user's residence is changed, the changed address can be confirmed by using the e-mail address that is linked with the postal address. Accordingly, it is possible to prevent the loss of the postal item.

In addition, according to the present invention, since a semi-permanent e-mail address is used instead of the postal address, which often changes, in a communication way between individuals, a sender can send the postal item by using only the e-mail address without worrying about the address change of recipient, even without knowing the address of the recipient.

Furthermore, according to the present invention, it is possible to easily manage the address by unifying dualistic contact information of the e-mail address and the postal address, which are used for on/off-line communication between individuals, into the e-mail address.

The exemplary embodiment of the present invention can be not necessarily implemented by only the above-described apparatus and/or method, but can be implemented by, for example, a program that achieves the function corresponding to the configuration of the exemplary embodiment of the present invention and a recording medium in which the program is recorded. This will be easily implemented from the above-described exemplary embodiment of the present invention by those skilled in the related art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A linkage system for linking an e-mail address with a postal address, comprising:
an e-mail address inputting section that receives an e-mail address;
a postal address mapping section that searches and confirms a postal address corresponding to the e-mail address, based on the received e-mail address; and
a postal item processing section that processes a postal item according to the postal address confirmed by the postal address mapping section.

2. The linkage system of claim 1, further comprising:
when the e-mail address is input into the e-mail address inputting section as either an image or a bar code, an e-mail address reading section that reads an e-mail address of a text type from either the image or the bar code; and
a postal address outputting section that outputs information on the searched postal address to a postal item as a character or a bar code so as to identify the postal address searched by the postal address mapping section.

3. The linkage system of claim 2, further comprising
a linkage database that stores the e-mail address and the postal address so as to correspond to each other, and provides the postal address to the postal address mapping section.

4. A linkage method of linking an e-mail address with a postal address by using a linkage system for linking the e-mail address with the postal address in a postal processor, comprising:
collecting an e-mail address from a postal item introduced into the postal processor;
searching information on the postal address corresponding to the collected e-mail address from a linkage database; and
after generating allocation information on a sorting compartment that sorts the postal item based on the searched postal address, controlling so as to sort the postal item according to the generated allocation information on the sorting compartment.

5. The linkage method of claim 4, wherein the collecting of the e-mail address comprises reading an e-mail address of a text type from either an image or a bar code of the e-mail address, when the received e-mail address is not input as text.

6. The linkage method of claim 5, wherein the e-mail address is input as any one of text, a bar code, and an image.

7. The linkage of claim 4, further comprising
outputting a postal address to the postal item as either a character or a bar code by using the searched postal address information.

8. The linkage method of claim 7, wherein the outputting of the postal address comprises:
determining whether or not a postal address corresponding to the received e-mail address is stored in the linkage system; and
outputting a message so that the postal item is returned, when the postal address is not stored in the linkage system.
